(19) United States
(12) Patent Application Publication
(10) Pub. No.: US 2002/0051227 A1
(43) Pub. Date: May 2, 2002

(54) Communication terminal and facsimile

(76) Inventors: Hirohiko Hirai, Fukuoka (JP); Masahiro Saigano, Fukuoka (JP)

Correspondence Address: RATNER AND PRESTIA, One Westlakes, Berwyn, Suite 301, P.O. Box 980, Valley Forge, PA, 19482-0980, US

(21) Appl. No.: 09/855,270

(22) Filed: May 15, 2001

(30) Foreign Application Priority Data
May 18, 2000 (JP) 2000-146560

(51) Int. Cl. H04N 1/40

(52) U.S. Cl. 358/444

(57) ABSTRACT

A facsimile capable of transmitting a still image captured with a digital still camera at excellent picture quality is provided. The facsimile comprises an SD memory card reader/writer for reading a still image stored in an SD memory card captured with a digital still camera, an image data format converter for converting the image data read by the SD memory card reader/writer into monochrome facsimile data or color facsimile data, and a modem for transmitting the converted image data in ordinary color facsimile transmission procedure or monochrome facsimile transmission procedure.

### FIELD OF THE INVENTION

The present invention relates to a communication terminal, and particularly to a facsimile capable of transmitting and receiving image data.

### BACKGROUND OF THE INVENTION

As an example of a communication terminal, a facsimile will be explained.

A facsimile is usually designed to transmit an image captured by a scanner and to receive the image sent with the above way.

A digital still camera replacing a silver salt photograph and being used as an image input device into a personal computer (PC) is put in market. Various memory cards are used as storage devices of still images. A memory card recording still images is inserted into a memory card reader/writer connected to a PC, and the images can be read into the PC.

A conventional facsimile captures an image recorded on a document with a scanner and transmits the image. The facsimile cannot transmit an image captured, for example, with the digital still camera.

### SUMMARY OF THE INVENTION

A facsimile which is capable of easily transmitting an image captured with a digital still camera with an excellent picture quality and which also prints the image with a printing unit in the facsimile is provided.

The facsimile comprises following units:

A scanner for capturing an image on a document;

A reader for loading and unloading a memory card and for reading image data in the memory card;

An operating unit for manipulating a dial or the like;

A modem for modulating and demodulating image data to obtain the data that can be transmitted and received through a communication line;

An image data format converter for converting the image data read out from the memory card into data for being transmitted in a facsimile format; and

A printing unit for printing the image corresponding to the image data read out from the memory card, the image corresponding to the image data received through the communication line, and the image captured with the scanner.

### BRIEF DESCRIPTION OF THE DRAWINGS

FIG. 1 is a perspective outlook of a facsimile according to an exemplary embodiment of the present invention.

FIG. 2 is a block diagram of a configuration of the facsimile according to the embodiment.

FIG. 3A through FIG. 3C are flowcharts of a process in the facsimile according to the embodiment.

### DESCRIPTION OF THE PREFERRED EMBODIMENT

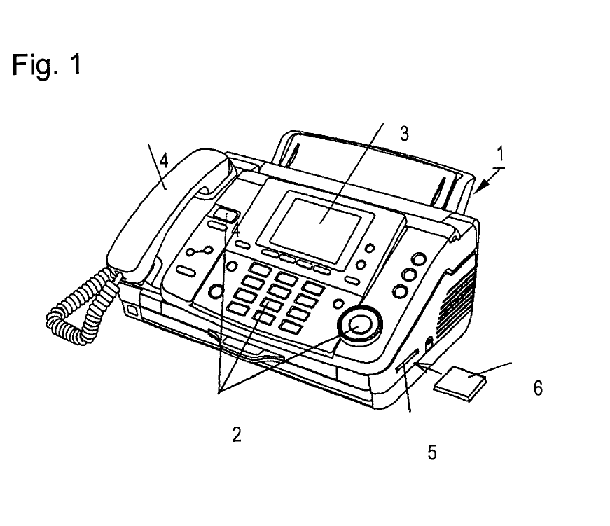

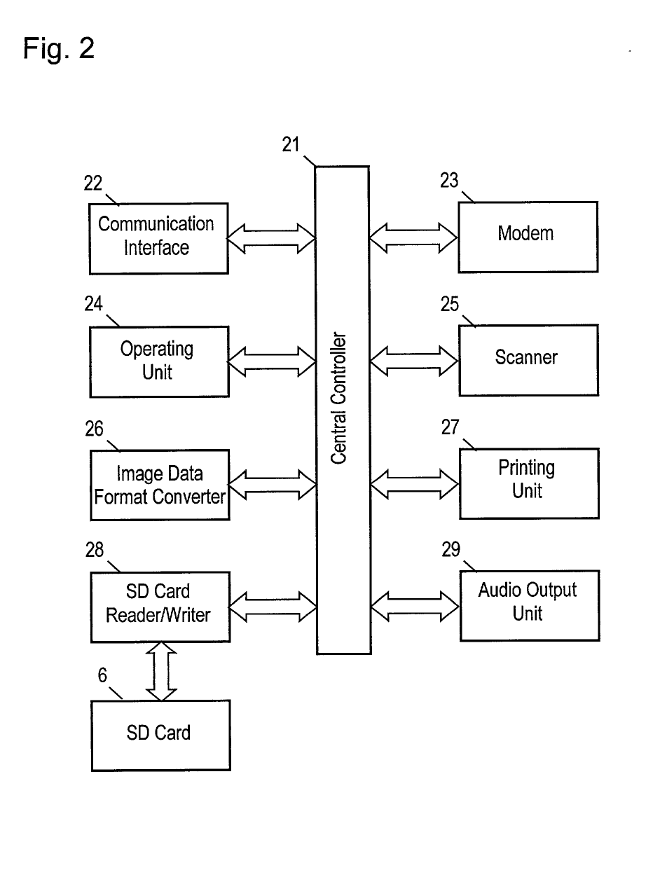

An exemplary embodiment of the invention will be described below while referring to accompanying drawings. FIG. 1 is a perspective outlook of a facsimile according to the embodiment, and FIG. 2 is a block diagram of a configuration of the facsimile according to the embodiment.

In FIG. 1, the facsimile comprises a facsimile body 1, an operating unit 2 for inputting an operation and instruction, a liquid crystal display (LCD) 3 for checking the image before being transmitted and for checking the received image before being printed, a handset 4 for talking, and a secure digital (SD) card reader/writer 5 for exchanging image data with a secure digital (SD) memory card 6 inserted into the reader/writer. The SD memory card 6 is a memory card conforming to a copyright protection function strongly demanded by major software contents maker around the world.

In FIG. 2, a central controller 21 comprises a CPU for processing various operations based on an operation program of the entire facsimile stored in a read-only memory (ROM), and a random access memory (RAM) for exchanging data with the CPU. The controller 21 controls the operation of the parts in the facsimile. A communication interface 22 connects between a telephone line (not shown) and the facsimile and transmits/receives various protocol data and image data. A modem 23 modulates and demodulates the image data with a destination facsimile. An operating unit 24 includes the operating unit 2 and the liquid crystal display 3 shown in FIG. 1. A scanner 25 reads an original image, and it is a color image sensor in the embodiment. An image data format converter 26 converts a JPEG image data in the JFIF format of TIFF, which is the image compressing format stored in the SD memory card, into a modified Huffman (MH) code which is the image data format for a monochromatic facsimile, or into a format conforming to the ITU-T T.81 Standard used in a color facsimile. A printing unit 27 prints an image, for example, the received facsimile image data in color or monochrome. A card reader/writer 28 exchanges image information with the SD memory card 6. An audio output unit 29 D/A-converts, amplifies, and issues the transmitted audio data. The output unit includes the handset 4 in FIG. 1.

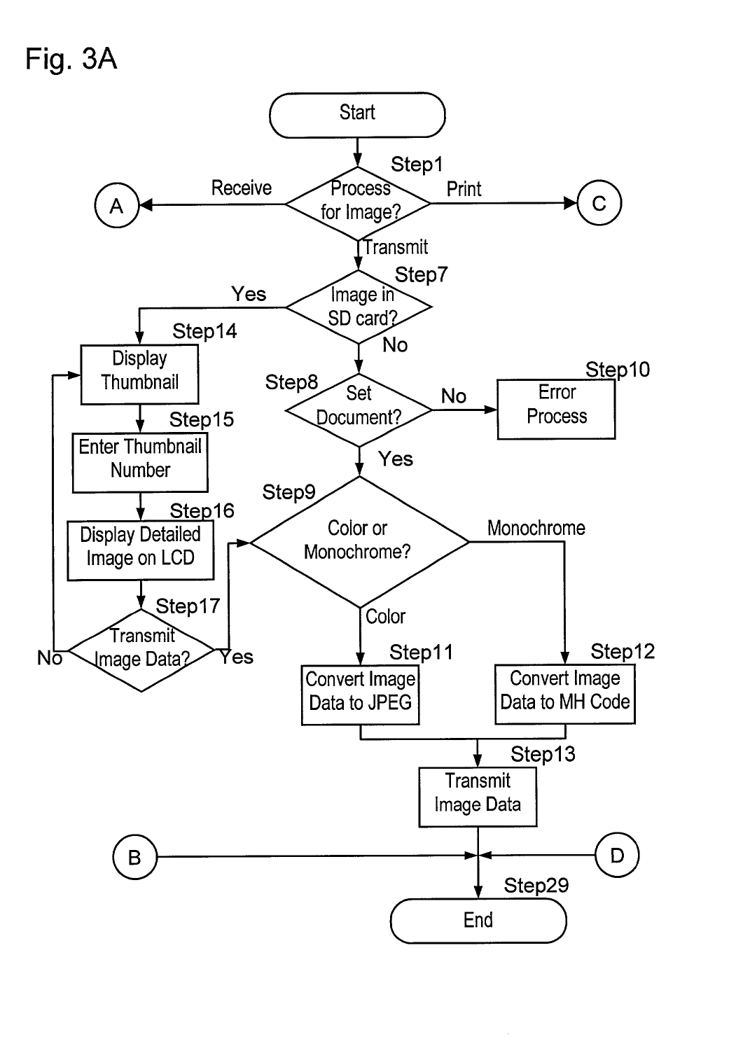

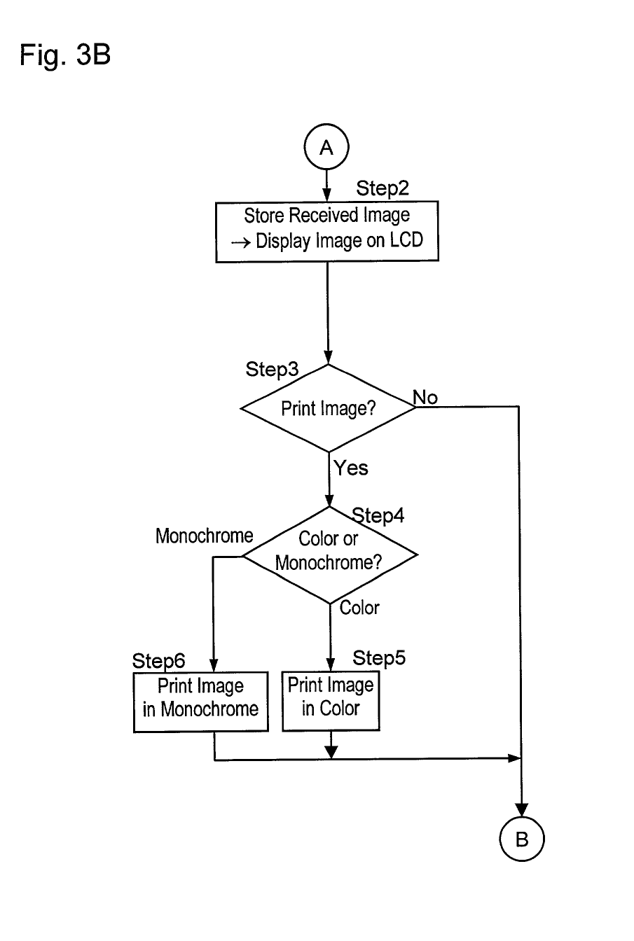

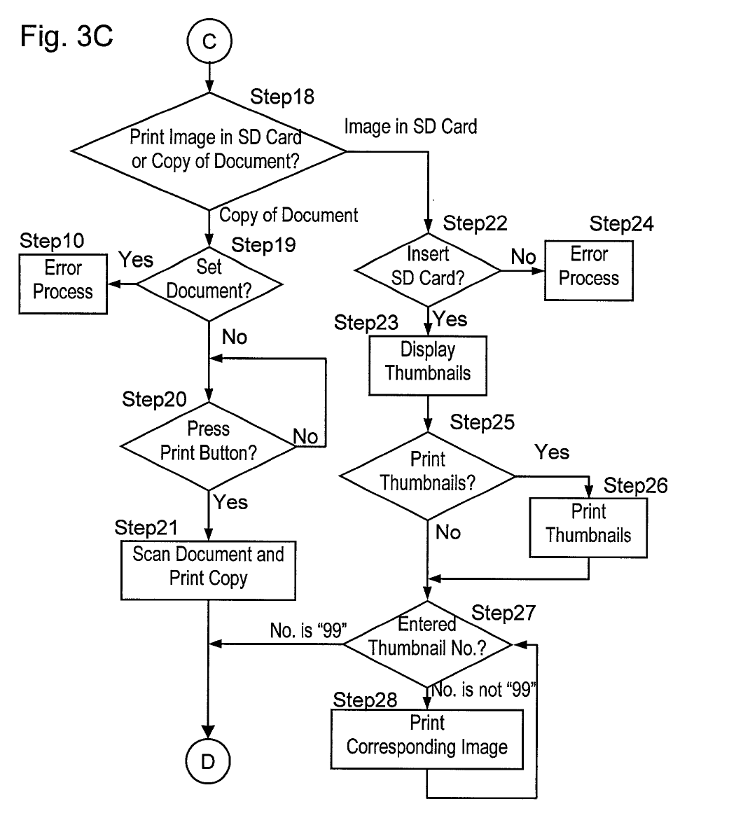

An operation in the facsimile having such configuration will be explained while referring to flowcharts in FIG. 3A through FIG. 3C. An operator firstly selects one of processes for an image, i.e., to transmit, receive, and print the image (step 1).

The image receiving operation will be explained with referring to FIG. 3B. A received image is stored in a storage device (an HDD or a RAM) in the facsimile (not shown) and displayed on the LCD 3 (step 1 and step 2). Then, the operator determines, with the operating unit 24, whether the image displayed on the LCD 3 is printed or not (step 3).

In the case that printing the image is determined, it is judged whether the image to be printed is in monochrome or color (step 4). If the image is in color, the printing unit 27 prints the image in color (step 5). If it is in monochrome, the printing unit 27 prints the image in monochrome (step 6), and the process terminates (step 29). If it is determined that the image is not printed at step 3, the operation terminates (step 29).

The transmitting process will be explained with referring to FIG. 3A. The operator determines, with the operating unit 24, which the facsimile transmits the image captured with the digital camera stored in the SD memory card 6 or the image on an original document similarly to an ordinary facsimile (step 7).

If the image in the SD memory card 6 is not transmitted, it is judged whether the original document is set in the facsimile main body 1 or not (step 8).

If the original document is not set, a message indicating that is displayed on the LCD 3, and an error-process is performed (step 10). If the original document is set, the operator sets, with the operating unit 24, that the image is transmitted in color or monochrome (step 9). If it is transmitted in color, the image of the original document captured with the scanner 25 is converted into the image data in a JPEG format conforming to the ITU-T T.81 Standard, which is the common standard of a color facsimile, in the image data format converter 26 (step 11). And then, the image is transmitted to a destination through the modem 23 and communication interface 22 (step 13). If the image is transmitted in monochrome, the image is converted into an MH code or the like, and transmitted similarly.

If it is determined that the image data in the SD memory card is transmitted at step 7, the central controller 21 controls the SD memory card reader/writer 28 and displays, on the LCD 3, all thumbnails of the images captured with the digital camera stored in the SD memory card 6 (step 14). According to the embodiment, the thumbnails of the images are displayed in the LCD 3, but they may be once printed with the printing unit 27. Then, the operator enters, with the operating unit, a thumbnail number corresponding to the thumbnail and being displayed on the LCD 3 in order to select the image to be transmitted from the displayed thumbnail (step 15). For example, the number is specified with pushing numeric keys “0” to “9” for ordinary dialing of the operating unit 24. It is also specified with twelve keys including additional keys “*” and “#” to the numeric keys. After the thumbnail number is entered, a detailed image corresponding to the thumbnail corresponding to the specified number is displayed on the LCD 3 (step 16). Upon confirming the image, the operator then judges whether it is transmitted or not (step 17). If it is transmitted, the operator instructs, for example, by pressing the key “#” of the operating unit 24. As a result, the operation goes to step 9. If it is not transmitted, the thumbnails are displayed again (step 14). Although not shown in the flowcharts in FIG. 3A through FIG. 3C, an escape process can be performed from any step. When the escape process is performed, the operation goes to step 29.

The printing operation will be explained with referring to FIG. 3C. The operator determines, with the operating unit 24, that the image in the SD memory card 6 is printed or that a copy of an original document is printed (step 18). If the copy of the original document is printed, it is judged whether the original document is set in the facsimile main body 1 or not (step 19). If the original document is not set, an error process is performed (step 10). If the original document is set, a print button of the operating unit 24 is pressed (step 20). Then, the image on the original document is captured with the scanner 25, and the copy of the document is printed by the printing unit 27 (step 21).

If to print the image captured with the digital camera stored in the SD memory card 6 is determined at step 18, it is judged if the SD memory card 6 is inserted into an SD memory card reader/writer 28 of the facsimile main body 1 or not (step 22). If the SD memory card 6 is not inserted, an error process is performed. In the error process, for example, a message requesting to insert the SD memory card is displayed on the LCD 3 (step 24). If the SD memory card 6 is inserted, all of plural thumbnails are displayed on the LCD 3. The operator requests to print the thumbnails with the operating unit 24. If the list is not necessary to print out, a thumbnail number of the image to be printed is entered. If being requested to print, the thumbnails and the thumbnail numbers corresponding to the thumbnails one by one are printed (step 26), and the operating unit waits for inputting the thumbnail number corresponding to the image to be printed (step 27). When operator enters the thumbnail number of the image requested to print (step 27), the detailed image corresponding to the number is printed by the printing unit 27 (step 28). When stopping printing it, the operator enters, a specific key, for example “99” so that the end process is performed (step 29).

The facsimile according to the embodiment can read the image captured with a digital still camera through a memory card, and transmit it to a destination. That is, an image having a higher picture quality can be transmitted to the destination as compared to transmitting an image produced in the way that a printed photograph is captured with a scanner.

The SD memory card presents the facsimile having excellent security and protecting the copyright securely.

The facsimile may include the image data format converter for converting the format of an image recorded in the memory card captured with a digital still camera, and the format of color image data sent out to a destination. And thus, the facsimile does not require an additional personal computer or the like for converting the data format.

The thumbnails of the image captured with a digital still camera stored in the memory card are once displayed on the LCD. Referring to the display, an operator can select the image to be actually printed, and only the desired image can be printed, and that hence prevents printing paper and printing ink from being used wastefully. Moreover, referring to the display, the operator can select the image to be transmitted, and it is not necessary to confirm the image with printed thumbnails prior to transmitting it. And thus, that also prevents printing paper and printing ink from being used wastefully.

What is claimed is:

1. A facsimile comprising:
a scanner for capturing an image;
a memory card reader for loading and unloading a memory card and reading image data from said memory card;
an operating unit;
a modem for modulating and demodulating image information into and from the data that can be transmitted and received through a communication line;
an image data format converter for converting image data read out from said memory card into data in a format for a facsimile transmission; and
a printing unit for printing, according to an instruction from said operating unit an image corresponding to the image data read out from said memory card, an image corresponding to the image data received through said communication line, and the image captured by said scanner.

2. The facsimile according to claim 1, wherein said printing unit prints, according to said operating unit, a thumbnail corresponding to the image data read out from said memory card.

3. The facsimile according to claim 2 further comprising:
a display for displaying the thumbnail corresponding to the image data read out from said memory card; and
a controller operable to:
select a specific thumbnail from the thumbnail displayed on said display with said operating unit; and
make said printing unit print an image corresponding to the specific thumbnail.

4. The facsimile according to claim 3, wherein said controller is operable to select to print the image corresponding to the specific thumbnail after said printing unit prints the thumbnail, and to print the image corresponding to the specific thumbnail without printing the thumbnail by the printing unit after said display displays the thumbnail.

5. The facsimile according to claim 3, wherein said operating unit comprises numeric keys for specifying the specific thumbnail.

6. The facsimile according to claim 3,
wherein said display displays a detailed image corresponding to the specific thumbnail if said operating unit specifies the specific thumbnail, and
wherein said printing unit prints the detailed image according to an instruction from said operating unit.

7. The facsimile according to claim 1, wherein said image data format converter converts the image data stored in said memory card into data conforming to the ITU-T T.81 Standard.

8. The facsimile according to claim 1,
wherein said image data format converter converts the image data stored in said memory card into first data conforming to the ITU-T T.81 Standard, and second data conforming to a modified Huffman (MH) code, and
wherein said operating unit selects one of the first and second data.

9. The facsimile according to claim 1, wherein said memory card is a secure digital (SD) memory card.

10. The facsimile according to claim 1, wherein said image data format converter converts JPEG image data in a JFIF format of TIFF into data conforming to the ITU-T T.81 Standard.

11. A communication terminal comprising:
a memory card reader for loading and unloading a memory card and reading image data from said memory card,
a receiver for receiving image information through a communication line, and
a printing unit for printing an image corresponding to the image data read out from said memory card, and an image data corresponding to the image information received through said communication line.

12. The communication terminal according to claim 11, wherein said printing unit prints a thumbnail corresponding to the image data read out from said memory card.

13. The communication terminal according to claim 12 further comprising:
a display for displaying the list of the thumbnail corresponding to the image data read out from said memory card, and
a controller operable to make said printing unit print an image corresponding to the specific thumbnail selected from the list of the thumbnail displayed on said display means.

14. The communication terminal according to claim 13, wherein said controller is operable to select to printing the image corresponding to the specific thumbnail after said printing unit prints the thumbnail, and to print the image corresponding to the specific thumbnail without printing the thumbnail after said display displays the thumbnail.

15. The communication terminal according to claim 13 further comprising numeric keys for specifying the specific thumbnail.

16. The communication terminal according to claim 13, wherein said display displays a detailed image of the specific thumbnail, and
wherein said printing unit prints the detailed image.

17. The communication terminal according to claim 11 further comprising an image data format converter for converting the image data stored in said memory card into data conforming to the ITU-T T.81 Standard.

18. The communication terminal according to claim 11, wherein said memory card is a secure digital (SD) memory card.

19. The communication terminal according to claim 11 further comprising an image data format converter for converting a JPEG image data in a JFIF format of TIFF into data conforming to the ITU-T T.81 Standard.
